(19) United States
(12) Patent Application Publication
(10) Pub. No.: US 2010/0143749 A1
(43) Pub. Date: Jun. 10, 2010

(54) SUBSTRATE MATERIAL FOR MAGNETIC HEAD AND METHOD FOR MANUFACTURING THE SAME

(75) Inventors: Shigeki Mori, Fukuoka (JP); Yusuke Hara, Fukuoka (JP); Shinzo Mitomi, Fukuoka (JP); Hidetaka Sakumichi, Osaka (JP)

Correspondence Address: Fleit Gibbons Gutman Bongini & Bianco PL, 21355 EAST DIXIE HIGHWAY, SUITE 115, MIAMI, FL, 33180, US

(73) Assignees: NIPPON TUNGSTEN CO., LTD., Fukuoka (JP); HITACHI METALS, LTD., Tokyo (JP)

(21) Appl. No.: 12/443,212

(22) PCT Filed: Mar. 30, 2007
(86) PCT No.: PCT/JP2007/057090

§ 371 Date: Dec. 21, 2009

(30) Foreign Application Priority Data
Sep. 29, 2006 (JP) 2006-269482

(51) Int. Cl. G11B 5/33; C04B 35/49

(52) U.S. Cl. 428/813; 264/611

(57) ABSTRACT

Disclosed is a substrate material for an AlTiC-based magnetic head, which is excellent in ultra-low flying-related properties as a material for a magnetic head, such as a TPC or AAB type for use as a thin-film magnetic head slider for HDD devices and a thin-film magnetic head for tape recording devices, where a flying height between a magnetic head element and a recording medium is extremely reduced, and usable in perpendicular recording heads, HAMR heads or the like. The magnetic head substrate material consists of a sintered body which contains 10 to 50 mass % of TiCₓO_{y}N_{z} (wherein: 0.70≦x<1.0; 0<y≦0.30; 0≦z≦0.1; and 0.70<x+y+z≦1.0) having an NaCl-type crystal structure, with the remainder being α-Al₂O₃, wherein compounds of Fe, Cr and Co are contained in an amount of no more than 0.02 mass % in total.

### TECHNICAL FIELD

The present invention relates to an α-Al₂O₃-TiCₓO_{y}N_{z} based (AlTiC-based) magnetic head, which is excellent in ultra-low flying-related properties as a material for a magnetic head, such as a transverse pressure contour (TPC) or advanced air bearing (AAB) type for use as a thin-film magnetic head slider for hard disk drive (HDD) devices and a thin-film magnetic head for tape recording devices, where a distance (flying height) between a magnetic head (writing/reading element) and a recording medium (disk) is as extremely small as about several nm, as well as in precision-processability, for example, by heat-induced processing including laser processing and plasma processing such as ion beam etching (IBE) and reactive ion etching (RIE), and stability in a flying height measurement, based on its nanocrystal structure, and usable in perpendicular recording heads, current-perpendicular-to-plane-giant-magnetoresistive (CCP-GMR) heads, ballistic magneto-resistive (BMR) heads or the like.

### BACKGROUND ART

A storage capacity of an HDD device goes on increasing due to a need for music and video recording. Along with a reduction in device size, development and production activates are made with a target of a twofold increase per two years in surface recording density (Mb/in²) of a recording medium. In order to increase the surface recording density, on the side of recording mediums, it is tried to shift a recording method from longitudinal magnetic recording to perpendicular magnetic recording and further to bit pattern recording. On the side of magnetic head, it is tried to shift a reading element from an inductive element to a magnetoresistive (MR) element, from the MR element to a giant magnetoresistive (GMR) element, from the GMR element to a tunnel magnetoresistive (TMR) element, and further from the TMR element to a CCP-GMR or BMR element. Further, in conjunction with shift to the perpendicular magnetic recording method, it is tried to shift a writing element from a ring head to a single-pole head (PMR), and further to a thermally assisted head.

Although a conventional magnetic head substrate material has been adaptable to HDD devices having a flying height of 10 nm or more, there are various challenges in adapting to HDD devices having lower flying heights, CCP-GMR and BMR magnetic heads, and perpendicular magnetic recording (PMR) magnetic head.

These challenges may be summarized in the following six points: (1) precision-processability of an air bearing surface (ABS) for lowering a flying height (distance between a magnetic head (writing/reading element) and a recording medium (disk)); (2) free-machinability during cutting and diamond polishing; (3) reduction in chipping during cutting; (4) reduction in residual particles; (5) lowering and stabilization of internal stress of a substrate; and (6) adjustment of thermal conductivity.

With a view to enhancing high-precision processability of an ABS as the challenge (1), the following Patent Document 1 proposes an Al₂O₃-TiC based sintered body which comprises Al₂O₃ as a primary component, and contains 25 to 35 weight % of TiC, and 0.05 to 0.3 weight % of Yb₂O₃ having a particle size of 0.01 to 0.5 μm as a sintering aid. In the Patent Document 1, it is described that aggregation of the sintering aid during IBE and RIE can be avoided. However, considering that there is not any limitation on grain sizes of Al₂O₃ and TiC in the sintered body, a processed surface must be roughened because grain boundaries between Al₂O₃ and TiC has a different etching rate from the crystal grains, and thereby a flying height of 10 nm or less would be hardly achieved.

The following Patent Document 2 proposes a magnetic head substrate material which contains 24 to 75 mol % of α-Al₂O₃, with the remainder being TiCₓO_{y}N_{z} (wherein 0.5≦x≦0.995, 0.005≦y<0.30, 0≦z≦0.2, and 0.505≦x+y+z≦1)) having an NaCl-type crystal structure, wherein an average grain size of TiCₓO_{y}N_{z} is 0.3 to 1.5 μm and a ratio of an average grain size of TiCₓO_{y}N_{z} to an average grain size of Al₂O₃ is 0.3 to 1.0, or at least one of or a part of one of crystal grains and aggregate grains of TiCₓO_{y}N_{z} exists in 9 μm² of square unit area of an arbitrary surface of the substrate material. However, as for properties of the substrate material disclosed in the Patent Document 2, a resulting RIE processed surface has a surface roughness of about 2500 Å or less, and an optimal surface roughness of about 1500 Å or less. Thus, IBE having a slower etching rate has to be used for achieving a flying height of 10 nm or less, which causes a problem with throughput.

With a view to enhancing free-machinability during cutting and lapping as the challenge (2), the following Patent Document 3 proposes a ceramic material which is high in hardness, nonmagnetic, highly reliable and free of drop-off of particles. The ceramic material is a sintered body of a ceramic raw material which includes titanium carbide, preferably in an amount of 30 to 40 weight %, and alumina, wherein titanium carbide in the sintered body has a medium grain size, preferably, of 1.5 to 2.5 μm, and wherein an amount of the titanium carbide having a grain size of 0.1 μm is controlled to be 10 weight % or less. However, under existing circumstances, due to a need for increasing a level of mirror finish of a cut surface, a diamond mesh size becomes reduced, for example, to #2000 or less. Thus, the ceramic material disclosed in the Patent Document 3 having a large medium grain size of high-hardness TiC would be liable to cause problems, such as wear of a diamond wheel, an increase in frequency of replacement of a grinding blade, a lowering in polishing rate, and seizure on the cut surface.

In regard to reduction in chipping during cutting as the challenge (3), the Patent Document 1 discloses a simple evaluation on chipping resistance, wherein the sintered body is cut using a diamond blade having a mesh size of #325, and the chipping resistance is considered to be good if an average chipping width is less than 25 μm. The Patent Document 3 discloses neither a specific mesh size of a diamond blade nor an evaluation using a diamond blade with a mesh size of #2000 or more. Thus, it is unable to make a comparative estimate.

In regard to reduction in residual particles as the challenge (4), the Patent Document 2 describes that particles drop off due to contact with a recording medium when a grain size becomes less than 0.3 μm. The Patent Document 3 describes that, TiC having a grain size of 0.1 μm or less causes a defect due to its high surface activity or its property concerning a reliability test and a CS/S (contact start/stop) test when it is used as a magnetic head slider. However, under existing circumstances, an ABS is coated with a diamond-like carbon (DLC), and therefore the above problems described in the Patent Documents 2 and 3 have already been solved.

However, as an unsolved problem, there remains existence of residual particles during precision cleaning of a magnetic head just before an HDD assembling process. Specifically, the residual particles may include chips during cutting and grinding sludge existing in pores of a substrate material. The residual particles may further include particles dropped off from a cut surface, which also has an impact on accuracy of the cutting surface.

In regard to lowering and stabilization of internal stress of a substrate as the challenge (5), the Patent Document 2 discloses a magnetic head substrate material, wherein an internal stress (τ) calculated by the following formula (1) is 1 MPa or less: τ=(B/A)×(Et/r²)×δ, wherein A and B are a constant dependent on a shape of a material (A: 0.67, B: 1.24); E is a Young's modulus; t is a thickness of a substrate; r is a radius of the substrate; τ is an internal stress; and δ is a warp amount of a disk, and a manufacturing method thereof. The following Patent Document 4 discloses a sintered body which contains Al₂O₃ as a primary component, and 20 to 40 weight % of TiC, wherein a residual internal stress is 0.08 kgf/mm², and a manufacturing method thereof, wherein a residual internal stress in one axial direction can be released by applying an isotropic pressure through a hot isostatic pressing (HIP) process, so as to reduce a final residual internal stress. However, in the Patent Document 2, a maximum value of the internal stress of the substrate material is excessively high. Further, in the Patent Document 4, the sintered body has to be slowly cooled because an internal stress is likely to be applied during a course of cooling after the HIP process, and thereby an occupancy rate of an HIP furnace would be liable to be increase to cause an increase in cost.

In regard to adjustment of thermal conductivity as the challenge (6), the Patent Documents 1 to 4 do not include any description thereabout, i.e., about adjusting thermal conductivity in a AlTiC-based magnetic head substrate material.

Although it is necessary to use a fine TiC raw powder or a fine TiCₓO_{y}N_{z} raw powder in order to achieve the above challenges (1) to (6), a conventional manufacturing method has the following problems.

Heretofore, as a technique for producing titanium carbide, there have been employed a method which comprises subjecting a mixed powder of titanium dioxide (TiO₂) and carbon to a heat treatment in a non-oxidation atmosphere at a high temperature of about 1500° C. to reduce and carburize TiO₂, and a direct carburization method for Ti and TiH₂.

However, a produced powder of TiC has a large size of 1 to 10 μm, and it is difficult to set a maximum particle size at 0.5 μm or less even if the powder is milled using a ball mill. Moreover, quality of powder will be inevitably degraded due to mixing of a milling medium. Although a jet mill is currently used in some cases, there remains difficulty in obtaining fine particles due to a need for multistage pulverization and other factors.

With a view to solving these problems, the following Patent Document 5 discloses a method which comprises putting a mixed solution of titanium tetrachloride (TiCl₄) and carbon chloride into a closed vessel containing molten magnesium (Mg), under an inert atmosphere, vacuum-separating an excess liquid Mg remaining after a magnesium-reducing reaction from magnesium chloride (MgCl₂), and collecting a TiC compound from the closed vessel after the vacuum-separating the liquid Mg from MgCl₂.

According to the method disclosed in the Patent Document 5, titanium carbide can be synthesized at a lower temperature of 900 to 1000° C. than ever before, wherein an obtained titanium carbide powder has a fine particle size of 50 nm, and a low free-carbon amount of 0.2 mass %, and wherein a lattice constant of titanium carbide is 4.3267 Å which is close to a theoretical value.

However, the titanium carbide powder obtained in this manner has a problem that it contains a large amount of impurities, such as 0.3 to 0.8 mass % of Mg, 0.1 to 0.3 mass % of Cl, and 0.1 to 0.6 mass % of Fe.

The following Patent Document 6 discloses a method which comprises dissolving in water a transition metal, and either one selected the group consisting of a titanium-containing water-soluble salt, a metatitanic acid, a TiO(OH)₂ slurry and an ultrafine titanium oxide powder, to prepare a mixed raw material, drying the mixed raw material to obtain a precursor powder, subjecting the precursor powder to a heat treatment to form an ultrafine Ti-transition metal composite oxide powder, mixing nano-sized carbon particles with the ultrafine Ti-transition metal composite oxide powder, drying the composite oxide powder, and subjecting the dried composite oxide powder to a heat treatment in a non-oxidation atmosphere at 1200 to 1350° C. to reduce and carburized the dried composite oxide powder so as to produce a TiC-Co composite powder having a titanium-carbide particle size of 35 to 81 nm.

In the method disclosed in the Patent Document 6, a content of transition metal is set at 1 weight % or more to allow the heat treatment for reduction/carburization to be performed at 1350° C. or less so as to obtain the ultrafine composite powder. However, it is difficult to produce a fine titanium carbide powder itself with high purity.

A method of synthesizing titanium carbide in a liquid phase has an advantage of being able to stably obtain fine carbide and facilitate mixing with other component. Further, the use of titanium alkoxide as a titanium source provides an advantage of being able to obtain a titanium carbide powder having a significantly low amount of other metal component mixed therein, at a relatively low cost.

However, the titanium carbide powder obtained by the liquid phase method contains free carbon as an impurity in an amount of several mass % or more. Thus, when the titanium carbide powder is used as a raw material to be sintered, the free carbon hinders sintering during a sintering process to cause a problem of being unable to obtain a dense sintered body.

For example, in the following Non-Patent Document 1, several types of dicarboxylic acids each having a different mode are mixed with titanium isopropoxide, and the mixture is dried and subjected to a heat treatment in an argon atmosphere containing 10% or less of hydrogen to obtain a titanium carbide powder. However, the obtained titanium carbide contains 4.2 mass % or more of free carbon.

As above, a method capable of synthesizing a titanium carbide having a maximum particle size of 200 nm or less, containing 0.5 mass % or less of free-carbon, and a low amount of a non-titanium metal, with mass productivity, has not been established.

Further, in case of producing a composite sintered body of titanium carbide and other ceramics including alumina, as a titanium carbide raw powder is more finely formed, an aggregate thereof is more likely to be formed to cause difficulty in obtaining a sintered body having titanium carbide uniformly dispersed thereover.

As a technique for solving this problem, a powder where a titanium carbon powder covers a surface of a ceramic powder, i.e., a powder having a core/shell structure, is effective to prevent aggregation of a titanium carbide powder to obtain a sintered body with an uniform-grain structure, in a process of producing a titanium carbide-dispersed ceramic sintered body, and also effective to suppress growth of ceramic grains during sintering.

A production method of such a composite powder is disclosed in the following Patent Document 7. The method disclosed in the Patent Document 7 comprises synthesizing a powder with a core/shell structure where a TiC thin film is formed on a surface of an alumina powder through a chemical vapor deposition (CVD) process, to obtain a sintered body having titanium carbide uniformly dispersed thereover. However, the CVD process obliges batch production within a vacuum apparatus, and thereby has a disadvantage of being unsuitable for mass production, and high in cost.

[Patent Document 1] JP No. 11-12026A

[Patent Document 2] JP 3039908

[Patent Document 3] JP No. 9-315848A

[Patent Document 4] JP No. 11-92213A

[Patent Document 5] JP No. 2005-47739A

[Patent Document 6] JP No. 2004-323968A

[Patent Document 7] JP No. 5-270820A

[Non-Patent Document 1] Tom Gallo, Carl GreCO, Claude Peterson, Frank Cambira and Johst Burk, Azko Chemicals Inc., Mat. Res. Soc. Symp. Proc. Vol. 271, 1992, p 887-892

### DISCLOSURE OF THE INVENTION

### Problem to be Solved by the Invention

In a substrate material for an AlTiC-based magnetic head, it is an object of the present invention to promote or achieve the above six challenges: (1) precision-processability of an ABS for lowering a flying height; (2) free-machinability during cutting and diamond polishing; (3) reduction in chipping during cutting; (4) reduction in residual particles; (5) lowering and stabilization of internal stress of a substrate; and (6) adjustment of thermal conductivity, so as to provide an AlTiC-based magnetic head, which is excellent in ultra-low flying-related properties as a material for a magnetic head, such as a TPC or AAB type for use as a thin-film magnetic head slider for HDD devices and a thin-film magnetic head for tape recording devices, where a flying height between a magnetic head and a recording medium is extremely reduced, and usable in perpendicular recording heads, heat-assisted magnetic recording (HAMR) heads or the like, and provide a method of stably manufacturing the substrate material.

[MEANS FOR SOLVING THE PROBLEM]

In order to improve precision-processability of an ABS for lowering a flying height as the challenge (1), the present invention provides a substrate material for a magnetic head, which consists of a sintered body containing of TiCₓO_{y}N_{z} (wherein: 0.70≦x<1.0; 0<y≦0.30; 0≦z≦0.1; and 0.70<x+y+z≦1.0) having an NaCl-type crystal structure, with the remainder being α-Al₂O₃ in which compounds of Fe, Cr and Co as magnetic impurities are contained in an amount of no more than 0.02 mass % in total.

That is, x, y and z in the TiCₓO_{y}N_{z} can be adjusted to allow an etching rate in α-Al₂O₃ and TiCₓO_{y}N_{z} by IBE or RIE to be equalized, while reducing a defect due to free carbon, and suppressing magnetic impurities having a negative effect on a magnetic circuit as the substrate material.

Preferably, in the present invention, the TiCₓO_{y}N_{z} has an average grain size dt satisfying the following relation: 0.05 μm≦dt≦0.5 μm, and the α-Al₂O₃ has an average grain size da satisfying the following relation: 0.1 μm≦da≦1.5 μm, wherein the entire sintered body has an average grain size d satisfying the following relation: 0.1 μm≦da≦0.7 μm. The sintered body is formed to have a fine-grain structure, because grain boundaries of the sintered body are selectively etched. This fine-grain structure also effectively contributes to stabilization of optical reflection during flying-height measurement.

In order to improve free-machinability during cutting and diamond polishing as the challenge (2), in the sintered body which contains 10 to 90 mass % of TiCₓO_{y}N_{z} (wherein: 0.70≦x<1.0; 0<y≦0.30; 0≦z≦0.1; and 0.70<x+y+z≦1.0) having an NaCl-type crystal structure, with the remainder being α-Al₂O₃, x, y and z in the TiCₓO_{y}N_{z} can be adjusted to obtain excellent cutting ability and diamond-polishing ability. Further, the sintered body may be formed to have a fine-grain structure, in such a manner that the average grain size dt of the TiCₓO_{y}N_{z}, the average grain size da of the α-Al₂O₃ and the average grain size d of the entire sintered body satisfy the following relations: 0.05 μm≦dt≦0.5 μm, 0.1 μm≦da≦1.5 μm, and 0.1 μm≦d≦0.7 μm, respectively, or may be formed in a desired grain dispersion state, in such a manner that one or more of or a part of crystal grains of the TiCₓO_{y}N_{z} exist in 2 μm² of square unit area of an arbitrary mirror-finished surface of the sintered body. This makes it possible to perform a cutting operation without wear of a diamond blade even using a diamond blade having a mesh size of #2000 or more, and obtain free-machinability during diamond polishing.

In regard to reduction in chipping during cutting as the challenge (3), in the sintered body which contains 10 to 50 mass % of TiCₓO_{y}N_{z} (wherein: 0.70≦x<1.0; 0<y≦0.30; 0≦z≦0.1; and 0.70<x+y+z≦1.0) having an NaCl-type crystal structure, with the remainder being α-Al₂O₃, x, y and z in the TiCₓO_{y}N_{z} can be adjusted to increase a bonding force between the TiCₓO_{y}N_{z} and the α-Al₂O₃ so as to reduce chipping during cutting. Further, the sintered body may be formed to have a fine-grain structure, in such a manner that the average grain size dt of the TiCₓO_{y}N_{z}, the average grain size da of the α-Al₂O₃ and the average grain size d of the entire sintered body satisfy the following relations: 0.05 μm≦dt≦0.5 μm, 0.1 μm≦da≦1.5 μm, and 0.1 μm≦d≦0.7 μm, respectively, or may be formed in a well-dispersed state, in such a manner that one or more of or a part of crystal grains of the TiCₓO_{y}N_{z} exist in 2 μm² of square unit area of an arbitrary mirror-finished surface of the sintered body. This makes it possible to reduce chipping during cutting.

In regard to reduction in residual particles as the challenge (4), the sintered body may be formed in such a manner that each of a pore having a circle-equivalent average diameter dp of 0.1 μm or more, and a noncircular defect caused by free carbon, exists in 25 μm² of square unit area of an arbitrary mirror-finished surface of the sintered body, in an average number of no more than one. This makes it possible to reduce the number of pores and a pore size.

In regard to lowering and stabilization of internal stress of a substrate as the challenge (5), the sintered body may be formed in such a manner that the average grain size dt of the TiCₓO_{y}N_{z}, the average grain size da of the α-Al₂O₃ and the average grain size d of the entire sintered body satisfy the following relations: 0.05 μm≦dt≦0.5 μm, 0.1 μm≦da≦1.5 μm, and 0.1 μm≦d≦0.7 μm, respectively, or may be formed in such a manner that one or more of or a part of crystal grains of the TiCₓO_{y}N_{z} exist in 2 μm² of square unit area of an arbitrary mirror-finished surface of the sintered body. In this case, the presence of fine grain boundaries suitable for stress relief, and desirably dispersed grains, allow stress to be lowered without occurrence of uneven distribution of stress. Further, the sintered body may contain, as a sintering aid, a compound of Y, Zr, and at least one of lanthanoids including La, Ce, Pr and Nd, in an amount of 0.01 to 0.5 mass % or less. This makes it possible to employ a sintering process which applies a low level of stress, such as a conventional sintering process or an HIP process, so as to provide lower internal stress.

In this case, an internal stress (τ) calculated by the following formula (I) may be set at 0.5 MPa or less: (1) τ=(B/A)×(Et/r²)×δ, wherein A and B are a constant dependent on a shape of a material (A: 0.67, B: 1.24); E is a Young's modulus; t is a thickness of a substrate; r is a radius of the substrate; τ is an internal stress; and δ is a warp amount of a disk which occurs when the disk is annealed at a temperature of 70% or more of a sintering temperature therefor while adjusting a cooling rate in the range of 0.5 to 3° C./min. This makes it possible to stably achieve low internal stress.

In regard to adjustment of thermal conductivity as the challenge (6), in the sintered body containing 10 to 50 mass % of TiCₓO_{y}N_{z} (wherein: 0.70≦x≦1.0; 0<y≦0.30; 0≦z≦0.1; and 0.70<x+y+z≦1.0) having an NaCl-type crystal structure, with the remainder being α-Al₂O₃, TiCₓO_{y}N_{z} in which each of y and z has a relatively large value, i.e., a material containing a relatively large amount of TiCₓO_{y}N_{z} which has oxygen and nitrogen in a relatively large amount, has a relatively low thermal conductivity, whereas TiCₓO_{y}N_{z} in which each of y and z has a relatively small value, i.e., a material containing a relatively small amount of TiCₓO_{y}N_{z} which has oxygen and nitrogen in a relatively large amount, has a relatively high thermal conductivity. In this manner, respective values of x, y, z of TiCₓO_{y}N_{z} can be adjusted while adjusting a content of the TiCₓO_{y}N_{z}, to adjust thermal conductivity.

In the present invention, the following methods (A) to (D) are employed to stably manufacture a sintered body capable of achieving the above challenges (1) to (6).

(A) A TiCₓO_{y}N_{z} powder (wherein: 0.90≦x<1.0; 0<y≦0.10; 0≦z≦0.05; and 0.90≦x+y+z≦1.0) with an NaCl-type crystal structure which has an average particle size dtp satisfying the following relation: 0.01 μm<dtp<0.2 μm, and contains 0.05 mass % or less of a non-titanium metal-containing material and 0.5 mass % or less of free carbon, and an α-Al₂O₃ powder having an average particle size dap satisfying the following relation: 0.05 μm<dap<0.7 μm, are prepared as a target raw material, and the target raw material is sintered.

(B) A TiCₓO_{y}N_{z} powder (wherein: 0.90≦x<1.0; 0≦y≦0.10; 0≦z≦0.05; and 0.75≦x+y+z≦1.0) with an NaCl-type crystal structure which has an average particle size dtp satisfying the following relation: 0.01 μm<dtp<0.2 μm, and contains 0.05 mass % or less of a non-titanium metal-containing material and 0.5 mass % or less of free carbon, an α-Al₂O₃ powder having an average particle size dap satisfying the following relation: 0.05 μm<dap<0.7 μm, with a TiO₂ powder or TiO₂ slurry having an average particle size dto satisfying the following relation: 0.01 μm<dto<0.5 μm, are prepared as a target raw material, and the target material is mixed/milled using, for example, a medium-agitation mill, such as a ball mill, a planetary mill, a rod mill, an attritor or a bead mill, and, after being dried/granulated, sintered.

(C) A target raw material including: a TiCₓO_{y}N_{z} powder (wherein: 0.90≦x<1.0; 0<y≦0.10; 0≦z≦0.05; and 0.90≦x+y+z≦1.0) having an NaCl-type crystal structure which has an average particle size dtp satisfying the following relation: 0.01 μm<dtp<0.2 μm, and contains 0.05 mass % or less of a non-titanium metal-containing material and 0.5 mass % or less of free carbon; an α-Al₂O₃ powder having an average particle size dap satisfying the following relation: 0.05 μm<dap<0.7 μm, and a TiO₂ powder or TiO₂ slurry having an average particle size dto satisfying the following relation: 0.01 μm<dto<0.5 μm, is mixed with a sintering aid consisting of 0.01 to 0.5 mass % or less of any compound of Y, Zr, and lanthanoids including La, Ce, Pr and Nd, and having an average particle size dao satisfying the following relation: 0.01 μm<dao<0.5 μm, and the obtained mixture is mixed/milled using, for example, a medium-agitation mill, such as a ball mill, a planetary mill, a rod mill, an attritor or a bead mill, and, after being dried/granulated, sintered.

(D) In each of the above methods (A) to (C), the target raw material is prepared as a TiCₓO_{y}N_{z} powder-α-Al₂O₃ composite powder, wherein the TiCₓO_{y}N_{z} powder (wherein: 0.90≦x<1.0; 0<y≦0.10; 0≦z≦0.05; and 0.90≦x+y+z≦1.0) having an NaCl-type crystal structure which has an average particle size dtp satisfying the following relation: 0.01 μm<dtp<0.2 μm, and contains 0.05 mass % or less of a non-titanium metal-containing material and 0.5 mass % or less of free carbon, covers a part or an entirety of a surface of the α-Al₂O₃ powder having an average particle size dap satisfying the following relation: 0.05 μm<dap<0.7 μm.

The TiCₓO_{y}N_{z} powder to be used in the above methods (A) to (C) is produced by the following process.

(a) A process of: preparing a liquid containing, as a carbon source, an organic substance dissolved in a solvent, wherein the organic substance has one or more OH or COOH groups each of which is a functional group coordinatable to titanium of titanium alkoxide, and includes no element, except C, H, N and O; mixing titanium alkoxide with the liquid in such a manner as to satisfy the following relation: 0.7≦α≦1.0, wherein α is a mole ratio of the carbon source to the titanium alkoxide (the carbon source/the titanium alkoxide), to form a precursor solution; and solidifying the precursor solution, and subjecting the obtained product to a heat treatment in a non-oxidation atmosphere, a vacuum atmosphere or a combination of a non-oxidation atmosphere and a vacuum atmosphere, at 1050 to 1500° C.

The TiCₓO_{y}N_{z}-α-Al₂O₃ composite powder to be used in the above method (D) is produced by the following process.

(b) A process of: preparing a liquid containing, as a carbon source, an organic substance dissolved in a solvent; mixing titanium alkoxide with the liquid in such a manner as to satisfy the following relation: 0.75≦α≦1.1, wherein α is a mole ratio of the carbon source to the titanium alkoxide (the carbon source/the titanium alkoxide), to form a precursor solution; and mixing an α-Al₂O₃ powder with the precursor solution to form a slurry, solidifying the slurry to obtain a product, and subjecting the product to a heat treatment in a non-oxidation atmosphere, a vacuum atmosphere or a combination of a non-oxidation atmosphere and a vacuum atmosphere, at 1050 to 1500° C.

Preferably, the carbon source to be used in the above processes (a) and (b) is at least one selected from the group consisting of: phenols including phenol and catechol; novolac-type phenolic resin; organic acid including salicylic acid, phthalic acid, catechol and anhydrous citric acid; and ethylenediamine tetraacetic acid (EDTA), or an organic substance having two or more ligands and containing a cyclic compound. Preferably, in the product obtained by solidifying the precursor solution, the carbon source is coordinated to titanium. Preferably, the titanium alkoxide is at least one selected from the group consisting of titanium (IV) methoxide, titanium (IV) ethoxide, titanium (IV) isopropoxide and titanium (IV) butoxide.

### EFFECT OF THE INVENTION

The present invention provides the following advantages.

In regard to precision-processability of an ABS for lowering a flying height as the challenge (1), x, y and z in the TiCₓO_{y}N_{z} can be adjusted to allow an etching rate in α-Al₂O₃ and TiCₓO_{y}N_{z} by IBE or RIE to be equalized. In addition, the formation of Al₂° C. as a reaction product of the α-Al₂O₃ can be suppressed to reduce a defect.

Further, magnetic impurities (Fe, Cr, Co) having a negative effect on a magnetic circuit as the substrate material can be reduced to 10 ppm or less.

Furthermore, a fine-grain structure can be achieved. This makes it possible to reduce an influence of the presence of grain boundaries susceptible to etching, on surface roughness, to provide enhanced roughness in a surface subjected to IBE or RIE so as to maximally narrow a flying height.

In regard to free-machinability during cutting as the challenge (2), a composition ratio between x, y and x of the TiCₓO_{y}N_{z} can be adjusted to achieve a fine-grain structure and a desired grain dispersion state. This makes it possible to adequately perform a cutting operation without wear of a diamond blade even using a diamond blade having a mesh size of #2000 or more. In addition, during diamond polishing, a polishing rate can be enhanced.

In regard to reduction in chipping during cutting as the challenge (3), in the sintered body which contains 10 to 50 mass % of TiCₓO_{y}N_{z} (wherein: 0.70≦x<1.0; 0<y≦0.30; 0≦z≦0.1; and 0.70<x+y+z≦1.0) having an NaCl-type crystal structure, with the remainder being α-Al₂O₃, x, y and z in the TiCₓO_{y}N_{z} can be adjusted to achieve an increased bonding force between the TiCₓO_{y}N_{z} and the α-Al₂O₃, as well as an excellent fine-grain structure with a desired grain dispersion, so as to reduce chipping.

In regard to reduction in residual particles as the challenge (4), a size of pore and an existing probability thereof are extremely small, and therefore residual particles can be reduced.

In regard to lowering and stabilization of internal stress of a substrate as the challenge (5), a fine-grain structure with a desired grain dispersion can be achieved to reduce internal stress without local stress distribution. Further, the sintered body may contain, as a sintering aid, a compound of Y, Zr, and at least one of lanthanoids including La, Ce, Pr and Nd, in an amount of 0.01 to 0.5 mass % or less. This makes it possible to select a sintering process which applies a low level of stress, such as a conventional sintering process or an HIP process, so that the internal stress to be calculated by the formula (I) can be reliably set at 0.5 MPa or less.

In regard to adjustment of thermal conductivity as the challenge (6), in the TiCₓO_{y}N_{z} having a fine-grain structure, x, y and z can be adjusted while adjusting a content of the TiCₓO_{y}N_{z}, to achieve this challenge.

Based on using a fine raw material as the target material, and specifying a production process of the target raw material, the magnetic head substrate material having the above excellent properties can be stably manufactured.

### BRIEF DESCRIPTION OF DRAWINGS

FIG. 1 is a graph showing a result of powder X-ray diffraction measurement of a composite material obtained in Example 1 under a vacuum atmosphere at a treatment temperature of 1350° C.

FIG. 2 is a transmission electron microscopic photograph of a TiCₓO_{y}N_{z} powder obtained in Example 1.

FIG. 3 is a graph showing a result of powder X-ray diffraction measurement of a composite material obtained in Example 2 at a treatment temperature of 1350° C.

FIG. 4 is a transmission electron microscopic photograph of a TiCₓO_{y}N_{z} powder obtained in Example 2.

FIG. 5 is an SEM photograph (×10,000) of a sample No. 5.

FIG. 6 is an SEM photograph (×10,000) of a sample No. 17.

### BEST MODE FOR CARRYING OUT THE INVENTION

The present invention will now be described based on an example.

### Example 1

100 g of salicylic acid having a molecular weight of 138.1 and serving as a carbon source was added to and stirringly dissolved in 300 ml of 2-methoxyethanol as a solvent to obtain a transparent and colorless liquid as a raw material of a precursor.

232 g of titanium isopropoxide which is in a liquid state at normal temperature, wherein the titanium isopropoxide contains about 39 g of titanium and has a molecular weight of 284.2, was added to the solution, and the mixture was stirred to obtain a homogeneous red-brown and highly transparent composite material in which the salicylic acid is coordinated to and substituted for a part of the titanium isopropoxide. The composite material was continuously stirred for 2 hours, and then heated in an oil bath under stirring to obtain a dried body. This dried body had an orange color, and a mole ratio of salicylic acid as the carbon source to titanium isopropoxide as a titanium source (carbon source/titanium alkoxide) a of 0.9.

Then, in a graphite crucible having an inner diameter of 300 mm and a height dimension of 200 mm, the obtained dried body was heated up to a maximum treatment temperature of 1050 to 1500° C. under a vacuum atmosphere of 13.33 Pa (0.1 Torr) and under an Ar and N₂ atmosphere, and then held at the maximum treatment temperature for 4 hours. Then, the dried body was naturally cooled to obtain a composite material.

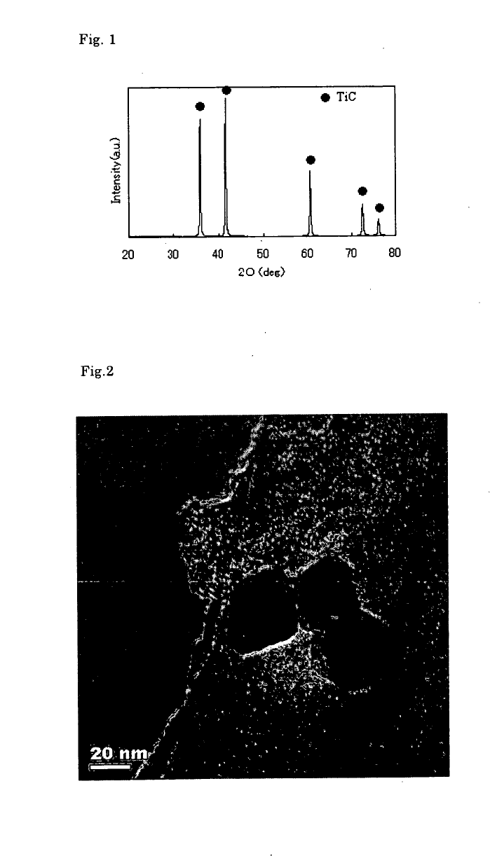

FIG. 1 shows a result of powder X-ray diffraction measurement of the composite material obtained under a vacuum atmosphere at a treatment temperature of 1350° C.

As is evident from the result, the obtained composite material had a single phase of TiCₓO_{y}N_{z} having a NaCl-type crystal structure, and a crystalline impurity, such as titanium oxide, was not contained therein. The synthesized titanium carbide had a lattice constant of 4.327 Å.

FIG. 2 shows a transmission electron microscopic (TEM) photograph of an obtained TiCₓO_{y}N_{z} powder. As seen in this photograph, the TiCₓO_{y}N_{z} powder has a maximum particle size of 100 nm or less. As a measurement result of the obtained TiCₓO_{y}N_{z} powder based on a carbon-precipitation-separation/combustion-infrared absorption method, an amount of free carbon in the obtained TiCₓO_{y}N_{z} powder was 0.07 mass %.

As a measurement result of the obtained TiCₓO_{y}N_{z} powder based on fluorescent X-ray analysis by a calibration curve method, an amount of a metal other than titanium (i.e., non-titanium metal) was 0.02 mass %. Carbon analysis, oxygen analysis and nitrogen analysis using a combustion-infrared absorption method were used for analyzing x, y and z in the TiCₓO_{y}N_{Z}.

Table 1 shows conditions of the treatment temperature and the atmosphere (pressure) for a TiCₓO_{y}N_{z} powder, and mixing amounts of α-Al₂O₃ and TiO₂

Then, under a condition that a composition ratio of the obtained TiCₓO_{y}N_{z} powder was changed in the range of 5 to 55 mass %, 350 g of a mixture comprising the TiCₓO_{y}N_{z} powder, with the remainder being α-Al₂O₃ having an average particle size da of 0.5 μm, was weighted out. The mixture was agitated for 24 hours by a ball mill container having a volume of 1000 ml and using 400 ml of alcohol solvent and mono-balls as a ball-milling medium. The obtained slurry was taken out of the ball mill container, and dried. Then, the dried milled powder was granulated using a sieve having an opening size of #50). In the same manner, a plurality of samples added with TiO₂ in the range of zero to 10 mass % were prepared. 60 g of the granulated powder was weighted out, and preliminarily compacted using a die of φ 78 mm, to obtain five compacts. Each of the obtained compacts was charged into a graphite mold of φ 78 mm, and subjected to hot-press (HP) sintering in a vacuum atmosphere at a temperature of 1800° C. and a pressure of 250 MPa. After removing burrs, a specific gravity of the sintered body was measured. Then, as an annealing treatment, in a furnace having a vacuum atmosphere, the sintered body was held at 1400° C. under an Ar atmosphere for 4 hours, and then cooled at a cooling rate of 1° C./min. The obtained sintered body was processed to have a thickness of 1.2 mm without applying processing stress thereto. Then, the sintered body was processed to have an outer periphery of φ 76.2 mm, and subjected to chamfering, and both opposite surfaces of the sintered body were simultaneously subjected to diamond polishing. In this manner, five samples were prepared. For an internal stress measurement, two of the samples were subjected to an annealing treatment for holding the sample in an Ar atmosphere at 1400° C. for 4 hours and cooling at a cooling rate of 1° C./min. Then, a warp amount was measured to calculate internal stress.

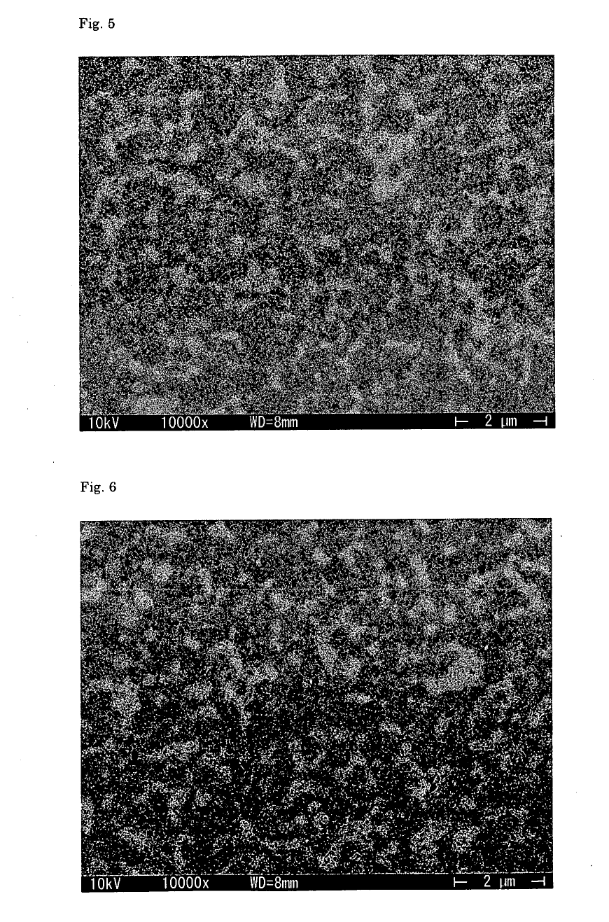

For a cutting test, each of two of the remaining samples was cut into a 50 mm square shape. The 50 mm square-shaped sample was attached on a cutting jig. A change in spindle load, a change in cut surface and a state of edge chipping were observed under a condition that the sample is cut using a diamond blade which has a diameter of φ 50.8 mm and a mesh size of #2000, at a speed of 10000 rpm while changing a feed speed. For an RIE test and an IBE test, the last one sample was subjected to masking and photolithography. Further, for a polishing test, each of six bar-shaped members obtained by the cutting test to have a width of 1 mm was processed to have a length of 20 mm. Then, under a condition that the six members are bonded to a polishing jig at even intervals of 60 degrees, and a unit load is set at 100 g/mm², a pre-polishing of the member is provided after grinding planarization of the member, while rotating an Sn plate having a diameter of 1000 mm and dropping diamond slurry having a particle size of less than 0.5 μm, and a polishing time and a polished amount were measured. Further, a sample having a size of φ 10 mm×1 mm thickness was prepared to measure thermal conductivity by a laser flash method. As seen in the scanning electron microscopic (SEM) photograph (×10,000) of a sample No. 5 in FIG. 5, a significantly fine-grain structure was observed. An amount of free carbon was defined by a non-circular pore and defect in SEM observation (×10,000).

Table 2 shows a composition ratio between x, y and z and a free-carbon amount in TiCₓO_{y}N_{z} in a powder state, together with a composition ratio between x, y and z in the TiCₓO_{y}N_{z} of a sintered body.

TABLE 1

| | | TiCₓO_{y}N_{z} | | | |
|---|---|---|---|---|---|
| | | Treatment temperature (° C.) | Composition (wt %) | | |
| No | | Atmosphere (MPa) | TiCₓO_{y}N_{z} | α-Al₂O₃ | TiO₂ |
| 1 | * | 1,000 vacuum | 35 | 65 | 0 |
| 2 | * | 1,550 vacuum | 35 | 65 | 0 |
| 3 | * | 1,350 vacuum | 5 | 95 | 0 |
| 4 | | 1,350 vacuum | 10 | 90 | 0 |
| 5 | | 1,350 vacuum | 25 | 75 | 0 |
| 6 | | 1,350 vacuum | 30 | 70 | 0 |
| 6-1 | | 1,350 Ar (0.1) | 30 | 70 | 0 |
| 6-2 | | 1,350 Ar (0.5) | 30 | 70 | 0 |
| 6-3 | | 1,350 N₂ (0.1) | 30 | 70 | 0 |
| 6-4 | | 1,350 N₂ (0.5) | 30 | 70 | 0 |
| 6-5 | | 1,350 H₂ (0.11) | 30 | 70 | 0 |
| 6-6 | | 1,350 H₂ (0.05) N₂ (0.06) | 30 | 70 | 0 |
| 7 | | 1,350 vacuum | 35 | 65 | 0 |
| 8 | | 1,350 vacuum | 45 | 55 | 0 |
| 9 | | 1,350 vacuum | 50 | 50 | 0 |
| 10 | * | 1,350 vacuum | 55 | 45 | 0 |
| 11 | | 1,350 vacuum | 30 | 69.9 | 0.1 |
| 12 | | 1,350 vacuum | 30 | 69 | 1.0 |
| 13 | | 1,350 vacuum | 30 | 65 | 5.0 |
| 14 | * | 1,350 vacuum | 30 | 67.5 | 15.0 |

* indicates a comparative sample
(Note)
6-6 was treated in an atmosphere of a mixed gas of H₂ and N₂

TABLE 2

| | | Powder: TiCₓO_{y}N_{z} | | | | Sintered Body: | | |
|---|---|---|---|---|---|---|---|---|
| | | | | | free carbon | TiCₓO_{y}N_{z} | | |
| No | | x | y | z | (wt %) | x | y | z |
| 1 | * | — | — | — | 2.8 | — | — | — |
| 2 | * | 0.98 | 0.01 | 0 | 0.06 | 0.97 | 0.01 | 0 |
| 3 | * | 0.99 | 0.01 | 0 | 0.03 | 0.98 | 0.02 | 0 |
| 4 | | 0.99 | 0.01 | 0 | 0.02 | 0.98 | 0.02 | 0 |
| 5 | | 0.99 | 0.01 | 0 | 0.04 | 0.98 | 0.02 | 0 |
| 6 | | 0.99 | 0.01 | 0 | 0.05 | 0.98 | 0.02 | 0 |
| 6-1 | | 0.99 | 0.01 | 0 | 0.07 | 0.98 | 0.02 | 0 |
| 6-2 | | 0.95 | 0.03 | 0 | 0.10 | 0.93 | 0.04 | 0 |
| 6-3 | | 0.92 | 0.02 | 0.06 | 0.05 | 0.90 | 0.08 | 0 |
| 6-4 | | 0.85 | 0.02 | 0.11 | 0.34 | 0.84 | 0.04 | 0.14 |
| 6-5 | | 0.80 | 0.01 | 0.01 | 0.02 | 0.79 | 0.03 | 0.02 |
| 6-6 | | 0.82 | 0.01 | 0.07 | 0.05 | 0.81 | 0.01 | 0.06 |
| 6-7 | | 0.99 | 001 | 0 | 0.05 | 0.98 | 0.01 | 0 |
| 6-8 | | 0.99 | 001 | 0 | 0.05 | 0.98 | 0.02 | 0 |
| 7 | | 0.99 | 0.01 | 0 | 0.07 | 0.98 | 0.02 | 0 |
| 8 | | 0.99 | 0.01 | 0 | 0.13 | 0.98 | 0.02 | 0 |
| 9 | | 0.99 | 0.01 | 0 | 0.20 | 0.98 | 0.02 | 0 |
| 10 | * | 0.99 | 0.01 | 0 | 0.25 | 0.98 | 0.02 | 0 |
| 11 | | 0.99 | 0.01 | 0 | 0.07 | 0.97 | 0.03 | 0 |
| 12 | | 0.99 | 0.01 | 0 | 0.07 | 0.92 | 0.08 | 0 |
| 13 | | 0.99 | 0.01 | 0 | 0.07 | 0.78 | 0.32 | 0 |
| 14 | * | 0.99 | 0.01 | 0 | 0.07 | 0.62 | 0.38 | 0 |

* indicates a comparative sample
(Note)
6-7 is a PCS sintered product
(Note)
6-8 is a hybrid sintered product

### Example 2

310 g of salicylic acid serving as a carbon source was added to and stirringly dissolved in 850 ml of 2-methoxyethanol as a solvent to obtain a transparent and colorless liquid as a raw material of a precursor.

650 g of titanium isopropoxide which is in a liquid state at normal temperature, wherein the titanium isopropoxide contains about 110 g of titanium, was added to the solution, and the mixture was stirred to obtain a homogeneous red-brown and highly transparent composite material in which the salicylic acid is coordinated to and substituted for a part of the titanium isopropoxide. The composite material was continuously stirred for 2 hours, and then 230 g of an α-Al₂O₃ powder having an average particle size da of 0.5 μm. Then, the obtained mixture was stirred using a stirrer for 3 hours, and heated in an oil bath under stirring to obtain a dried body. This dried body had an orange color, and a mole ratio of salicylic acid as the carbon source to titanium isopropoxide as a titanium source (carbon source/titanium alkoxide) α of 1.0. Further, in the same manner, a plurality of different composite powders were obtained by changing an amount of α-Al₂O₃ powder to be added.

Then, in a graphite crucible having an inner diameter of 300 mm and a height dimension of 200 mm, the obtained dried body was heated up to a maximum treatment temperature of 1050 to 1500° C. under a vacuum atmosphere of 13.33 Pa (0.1 Torr), and then held at the maximum treatment temperature for 4 hours. Then, the dried body was naturally cooled to obtain a composite material.

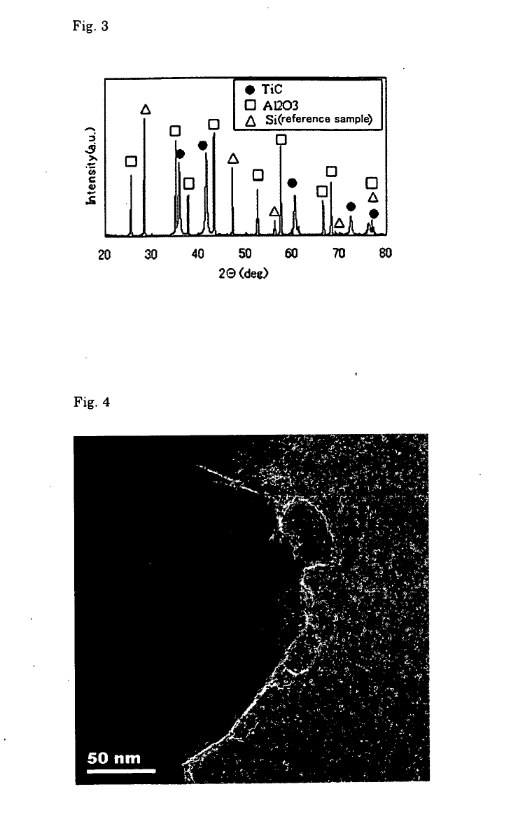

FIG. 3 shows a result of powder X-ray diffraction measurement of the composite material obtained at a treatment temperature of 1350° C. As is evident from the result, the obtained composite material had only alumina and TiCₓO_{y}N_{z} having a NaCl-type crystal structure, and a crystalline impurity, such as titanium oxide, was not contained therein. The synthesized titanium carbide had a lattice constant of 4.329 Å.

FIG. 4 shows a transmission electron microscopic (TEM) photograph of an obtained TiCₓO_{y}N_{z} powder. As seen in this photograph, the TiCₓO_{y}N_{z} powder covers alumina particles, and has a maximum particle size of 100 nm or less. As a measurement result of the obtained TiCₓO_{y}N_{z} powder based on a carbon-precipitation-separation/combustion-infrared absorption method, a ratio of free-carbon amount to TiCₓO_{y}N_{z} in the composite material was 0.03 mass %.

Table 3 shows conditions of the treatment temperature and the atmosphere (pressure) for a TiCₓO_{y}N_{z} powder, and mixing amounts of α-Al₂O₃ and TiO₂.

Then, the dried milled powder was granulated using a sieve having an opening size of #50. 60 g of the granulated powder was weighted out, and preliminarily compacted using a die of φ 78, to obtain five compacts. Each of the obtained compacts was charged into a graphite mold of φ 78, and subjected to hot-press (HP) sintering in a vacuum atmosphere at a temperature of 1700° C. and a pressure of 35 MPa. After removing burrs, a specific gravity of the sintered body was measured. Further, the sintered body was subjected to a HIP treatment in an Ar atmosphere at a temperature of 1500° C. and a pressure of 200 MPa, and a specific gravity of the obtained sintered body was measured. Then, as an annealing treatment, in a furnace having a vacuum atmosphere, the sintered body was held at 1400° C. under an Ar atmosphere for 4 hours, and then cooled at a cooling rate of 1° C./min.

The obtained sintered body was evaluated in the same manner as that in the Example 1. FIG. 6 shows an SEM photograph (×10,000) of a sample No. 17. A significantly fine-grain structure was observed.

Table 4 shows a composition ratio between x, y and z and a free-carbon amount in TiCₓO_{y}N_{z} in a powder state, together with a composition ratio between x, y and z in the TiCₓO_{y}N_{z} of a sintered body.

TABLE 3

| | | α-Al₂O₃ | | | |
|---|---|---|---|---|---|
| | | TiCₓO_{y}N_{z} | | | |
| | | Treatment temperature (° C.) | Composition (wt %) | | |
| No | | Atmosphere (MPa) | TiCₓO_{y}N_{z} | α-Al₂O₃ | TiO₂ |
| 15 | * | 1,000 vacuum | Three phases of TiCₓO_{y}N_{z}, TiOₙ and α-Al₂CO₃ | | |
| | | | are formed, and treatment temperature is out of range | | |
| 16 | * | 1,550 vacuum | It is difficult to adjust composition due to | | |
| | | | vaporization of α-Al₂O₃ | | |
| 17 | | 1,350 vacuum | 30 | 70 | 0 |

* indicates a comparative sample

TABLE 4

| | | Powder: TiCₓO_{y}N_{z} | | | | Sintered Body: | | |
|---|---|---|---|---|---|---|---|---|
| | | | | | free carbon | TiCₓO_{y}N_{z} | | |
| No | | x | y | z | (wt %) | x | y | z |
| 15 | * | — | — | — | — | — | — | — |
| 16 | * | — | — | — | — | — | — | — |
| 17 | | 0.99 | 0.01 | 0 | 0.03 | 0.98 | 0.02 | 0 |

* indicates a comparative sample

### Example 3

A powder was prepared using a NaCl-type crystal structured TiCₓO_{y}N_{z}-α-Al₂O₃ composite powder prepared in the same manner as that in the Example 2, under a condition that an amount of α-Al₂O₃ is fixed at 70 mass %, and an amount of TiO₂ is changed in the range of zero to 5 mass % in the same manner as that in the Example 1. A composition was set to that of No. 6 in Table 1.

This powder was preliminarily compacted. The compact was charged into a graphite mold and subjected to a pulse-current sintering (PCS) or current/hot-press sintering (hybrid sintering) in any one of or a combination of a vacuum atmosphere, a nitrogen atmosphere and an Ar atmosphere, at a sintering temperature of 1400 to 1800° C. and a pressure of 20 to 50 MPa. The evaluation was performed in the same manner as that in the Example 1. As a reference sample, the sample No. 6 in Table 1 in the Example 1 was used.

### Example 4

A slurry was prepared using a NaCl-type crystal structured TiCₓO_{y}N_{z}-alumina composite powder prepared in the same manner as that in the Example 2, under a condition that an amount of a compound (sintering aid) of Zr, Y and at least one of lanthanoids including La, Ce, Pr and Nd, is changed in the range of zero to 1.0 mass % in the same manner as that in the Example 1. 5 mass % of PVB-based organic binder was added to the slurry. Then, the mixture was dried and granulated by a spray dryer. The powder was compacted in a die at a pressure of 150 MPa, and, after removing the binder by a gas flow of an N₂ atmosphere at a temperature of 1000° C., sintered in an N₂ and Ar atmosphere at a temperature of 1600 to 1900° C. Then, the obtained sintered body was subjected to an HIP treatment in an Ar atmosphere at a temperature of 1500° C. and 200 MPa. Then, an annealing treatment and subsequent processes were performed in the same manner as those in the Example 1.

Table 5 shows a type and an amount of sintering aid to be added. Table 6 shows a composition ratio between x, y and z and a free-carbon amount in TiCₓO_{y}N_{z} in a powder state, together with a composition ratio between x, y and z in the TiCₓO_{y}N_{z} of a sintered body, and sintering conditions. In Table 6, samples Nos. 19-1, 19-2, 19-3 were prepared under different sintering conditions (N₂ pressures), respectively.

TABLE 5

Type and Amount of Sintering Aid (wt %)

| No | | ZrO₂ | Y₂O₃ | LaO₂ | CeO₂ | Pr₂O₃ | NdO₂ |
|---|---|---|---|---|---|---|---|
| 18 | | 0 | 0.1 | 0 | 0 | 0 | 0 |
| 19 | | | 0.3 | | | | |
| 20 | | | 0.5 | | | | |
| 21 | * | | 1.0 | | | | |
| 22 | | 0.3 | | | | | |
| 23 | | | | 0.3 | | | |
| 24 | | | | | 0.3 | | |
| 25 | | | | | | 0.3 | |
| 26 | | | | | | | 0.3 |
| 27 | | 0.3 | 0.1 | | | | |
| 28 | | | 0.05 | | | | |
| 29 | | | 0.02 | | | | |
| 30 | * | 0 | 0 | 0 | 0 | 0 | 0 |

* indicates a comparative sample

TABLE 6

| | | | | | | | | | Sintering |
|---|---|---|---|---|---|---|---|---|---|
| | | Powder: TiCₓO_{y}N_{z} | | | | Sintered Body: TiCₓO_{y}N_{z} | | | Atmosphere |
| No | | x | y | z | Free carbon | x | y | z | (MPa) |
| 18 | | 0.99 | 0.01 | 0 | 0.03 | 0.93 | 0.02 | 0.05 | Ar (0.1) |
| 19 | | 0.99 | 0.01 | 0 | 0.03 | 0.93 | 0.02 | 0.05 | Ar (0.1) |
| 20 | | 0.99 | 0.01 | 0 | 0.03 | 0.90 | 0.04 | 0.06 | Ar (0.1) |
| 21 | * | 0.99 | 0.01 | 0 | 0.03 | 0.81 | 0.10 | 0.09 | Ar (0.1) |
| 22 | | 0.99 | 0.01 | 0 | 0.03 | 0.98 | 0.02 | 0.05 | Ar (0.1) |
| 23 | | 0.99 | 0.01 | 0 | 0.03 | 0.98 | 0.02 | 0.05 | Ar (0.1) |
| 24 | | 0.99 | 0.01 | 0 | 0.03 | 0.98 | 0.02 | 0.05 | Ar (0.1) |
| 25 | | 0.99 | 0.01 | 0 | 0.03 | 0.98 | 0.02 | 0.05 | Ar (0.1) |
| 26 | | 0.99 | 0.01 | 0 | 0.03 | 0.98 | 0.02 | 0.05 | Ar (0.1) |
| 27 | | 0.99 | 0.01 | 0 | 0.03 | 0.98 | 0.02 | 0.05 | Ar (0.1) |
| 19-1 | | 0.99 | 0.01 | 0 | 0.03 | 0.90 | 0.02 | 0.07 | N₂ (0.1) |
| 19-2 | | 0.99 | 0.01 | 0 | 0.03 | 0.87 | 0.02 | 0.09 | N₂ (0.2) |
| 19-3 | * | 0.99 | 0.01 | 0 | 0.03 | 0.81 | 0.02 | 0.17 | N₂ (0.5) |

* indicates a comparative sample

An evaluation of the sintered bodies was performed as follows. A content of TiOₙ was determined by an X-ray diffraction peak height. A precision-processability of an ABS was evaluated by a surface roughness after processing to a depth of 0.1 μm as for IBE, and evaluated by a surface roughness after processing to a depth of 1 μm as for RIE. A criterion for the evaluation is shown in Table 7. A diamond polishing ability was evaluated by a comparison of a polished amount per unit time with that of a reference sample. A criterion for the evaluation is shown in Table 8. A relationship between a spindle load and a cutting rate was expressed as a first-order approximation formula, and a level of the inclination was compared with that of a reference sample. A criterion for the evaluation is shown in Table 9. A surface roughness of a cut surface was evaluated by a surface roughness after a cut distance of 5000 mm. A criterion for the evaluation is shown in Table 10. Chipping during cutting was checked by observing a bar member after a cut distance of 5000 mm using an SEM (×1000). A checking point was set at arbitrary three positions, and the chipping was evaluated by a chipping width. A criterion for the evaluation is shown in Table 11. The presence of residual particles was evaluated by an average value of the number of pores and the number of amorphous defects caused by free carbon having a circle-equivalent average diameter of 0.1 μm or more and the number of amorphous defects caused by free carbon having a circle-equivalent average diameter of 0.1 μm or more, based on SEM (×5000) observation at any three points in a cut mirror surface. A criterion for the evaluation is shown in Table 12. A criterion for an evaluation on internal stress is shown in Table 13. A criterion for an evaluation on thermal conductivity is shown in Table 14. In the evaluation in the Table 14, the double-circle mark, the single-circle mark and the black-circle mark represent “high thermal conductivity, “the same level as that in conventional substrates” and “low thermal conductivity”. Tables 15 and 16 show a comprehensive evaluation of each sample. As is evident from the comprehensive evaluation, the inventive product is an excellent magnetic head substrate material, achieving the above six challenges.

TABLE 7

| | IBE (R: Ra) | | | RIE (R: Ra) | | |
|---|---|---|---|---|---|---|
| Surface Roughness nm | R ≦ 50 | 50 < R ≦ 100 | 100 < R | R ≦ 100 | 100 < R ≦ 200 | 200 < R |
| Evaluation | ◯ | Δ | X | ◯ | Δ | X |

TABLE 8

| Comparison with | Diamond Polishing Ability | | |
|---|---|---|---|
| Reference Sample | 105% ≧ Pr | 105% > Pr ≧ 95% | 95% > Pr |
| Evaluation | ◯ | δ | X |

TABLE 9

| Comparison with | Cutting Ability | | |
|---|---|---|---|
| Reference Sample | 105% ≧ Pr | 105% > Pr ≧ 95% | 95% < Pr |
| Evaluation | ◯ | δ | X |

TABLE 10

| | Cut Surface Accuracy (R: Ra) | | |
|---|---|---|---|
| Surface Roughness nm | R ≦ 70 | 70 < R ≦ 130 | 130 < R |
| Evaluation | ◯ | δ | X |

TABLE 11

| | Pitching | | |
|---|---|---|---|
| Depth μm | D ≦ 2 | 2 < D ≦ 5 | 5 < D |
| Evaluation | ◯ | δ | X |

TABLE 12

| | Number of Pores and Defects (0.1 μm ≦ d) | | |
|---|---|---|---|
| Average Number/25 μm² | n < 1 | 1 < n ≦ 2 | 2 < n |
| Evaluation | ◯ | δ | X |

TABLE 13

| | Internal Stress | | |
|---|---|---|---|
| Stress MPa | σ ≦ 0.5 | 0.5 < σ ≦ 1 | 1 < σ |
| Evaluation | ◯ | δ | X |

TABLE 14

| | Thermal Conductivity | | |
|---|---|---|---|
| Thermal Conductivity W/m · k | t ≧ 25 | 25 > t ≧ 23 | 23 > t |
| Evaluation | ⊚ | ◯ | • |

TABLE 15

| | | TiOₙ | Comprehensive Property Evaluation | | | | | | | | |
|---|---|---|---|---|---|---|---|---|---|---|---|
| | | Amount | | | | | Cut | | | | Thermal |
| No | | wt % | IBE | RIE | DP | Cutting | Surface | Chip | Pore | Stress | Conductivity |
| 1 | * | 0 | X | X | ◯ | ◯ | ◯ | X | X | X | |
| 2 | * | 0 | Δ | Δ | Δ | X | X | Δ | X | ◯ | ◯ |
| 3 | * | 0 | X | X | X | X | X | X | X | Δ | ⊚ |
| 4 | | 0 | Δ | Δ | Δ | Δ | Δ | ◯ | ◯ | ◯ | ⊚ |
| 5 | | 0 | ◯ | ◯ | ◯ | ◯ | ◯ | ◯ | ◯ | ◯ | ⊚ |
| 6 | | 0 | ◯ | ◯ | ◯ | ◯ | ◯ | ◯ | ◯ | ◯ | ⊚ |
| 6-1 | | 0 | ◯ | ◯ | ◯ | ◯ | ◯ | ◯ | ◯ | ◯ | ⊚ |
| 6-2 | | 0 | ◯ | ◯ | ◯ | ◯ | ◯ | ◯ | ◯ | ◯ | ◯ |
| 6-3 | | 0 | ◯ | ◯ | ◯ | ◯ | ◯ | ◯ | ◯ | ◯ | ⊚ |
| 6-4 | | 0 | ◯ | ◯ | Δ | Δ | Δ | ◯ | ◯ | ◯ | ⊚ |
| 6-5 | | 0 | ◯ | ◯ | Δ | Δ | Δ | ◯ | ◯ | ◯ | ◯ |
| 6-6 | | 0 | ◯ | ◯ | Δ | Δ | Δ | ◯ | ◯ | ◯ | ◯ |
| 6-7 | | 0 | ◯ | ◯ | ◯ | ◯ | ◯ | ◯ | ◯ | ◯ | ⊚ |
| 6-8 | | 0 | ◯ | ◯ | ◯ | ◯ | ◯ | ◯ | ◯ | ◯ | ⊚ |
| 7 | | 0 | ◯ | ◯ | ◯ | ◯ | ◯ | ◯ | ◯ | ◯ | ⊚ |
| 8 | | 0 | ◯ | ◯ | Δ | ◯ | ◯ | ◯ | ◯ | ◯ | ◯ |
| 9 | | 0 | ◯ | ◯ | Δ | Δ | ◯ | ◯ | ◯ | ◯ | ◯ |
| 10 | * | 0 | ◯ | ◯ | X | Δ | Δ | ◯ | Δ | ◯ | ◯ |
| 11 | | 0 | ◯ | ◯ | ◯ | ◯ | ◯ | ◯ | ◯ | ◯ | ⊚ |
| 12 | | 0.1 | ◯ | Δ | ◯ | ◯ | ◯ | ◯ | ◯ | ◯ | ⊚ |
| 13 | | 0.48 | Δ | Δ | ◯ | ◯ | ◯ | ◯ | ◯ | ◯ | ◯ |
| 14 | * | 1.5 | X | X | ◯ | ◯ | ◯ | ◯ | ◯ | Δ | |
| 17 | | 0 | ◯ | ◯ | ◯ | ◯ | ◯ | ◯ | ◯ | ◯ | ⊚ |

* indicates a comparative sample

TABLE 16

| | | TiOₙ | Comprehensive Property Evaluation | | | | | | | | |
|---|---|---|---|---|---|---|---|---|---|---|---|
| | | Amount | | | | | Cut | | | | Thermal |
| No | | wt % | IBE | RIE | DP | Cutting | Surface | Chip | Pore | Stress | Conductivity |
| 18 | | 0 | Δ | Δ | ◯ | ◯ | ◯ | ◯ | Δ | ◯ | ⊚ |
| 19 | | 0 | ◯ | ◯ | ◯ | ◯ | ◯ | ◯ | ◯ | ◯ | ⊚ |
| 19-1 | | 0 | ◯ | ◯ | ◯ | Δ | ◯ | ◯ | ◯ | ◯ | ⊚ |
| 19-2 | | 0 | ◯ | ◯ | ◯ | Δ | Δ | ◯ | ◯ | ◯ | ⊚ |
| 19-3 | * | 0 | ◯ | ◯ | Δ | X | X | Δ | Δ | ◯ | ◯ |
| 20 | | 0 | Δ | Δ | ◯ | ◯ | ◯ | ◯ | ◯ | ◯ | ⊚ |
| 21 | * | 0 | X | X | ◯ | ◯ | ◯ | ◯ | ◯ | ◯ | ◯ |
| 22 | | 0 | ◯ | ◯ | ◯ | ◯ | ◯ | ◯ | ◯ | ◯ | ⊚ |
| 23 | | 0 | ◯ | ◯ | ◯ | ◯ | ◯ | ◯ | ◯ | ◯ | ⊚ |
| 24 | | 0 | ◯ | ◯ | ◯ | ◯ | ◯ | ◯ | ◯ | ◯ | ⊚ |
| 25 | | 0 | ◯ | ◯ | ◯ | ◯ | ◯ | ◯ | ◯ | ◯ | ⊚ |
| 26 | | 0 | ◯ | ◯ | ◯ | ◯ | ◯ | ◯ | ◯ | ◯ | ⊚ |
| 27 | | 0 | Δ | Δ | ◯ | ◯ | ◯ | ◯ | ◯ | ◯ | ⊚ |
| 28 | | 0 | Δ | Δ | ◯ | ◯ | ◯ | ◯ | ◯ | ◯ | ⊚ |
| 29 | | 0 | Δ | Δ | ◯ | ◯ | Δ | Δ | Δ | ◯ | ◯ |
| 30 | | 0 | X | X | ◯ | ◯ | X | X | X | ◯ | |

* indicates a comparative sample

1. A substrate material for a magnetic head, consisting of a sintered body which contains 10 to 50 mass % of TiCₓO_{y}N_{z} (wherein: 0.70≦x<1.0; 0<y≦0.30; 0≦z≦0.1; and 0.70<x+y+z≦1.0) having an NaCl-type crystal structure, with the remainder being α-Al₂O₃ in which compounds of Fe, Cr and Co as magnetic impurities are contained in an amount of no more than 0.02 mass % in total.

2. The substrate material as defined in claim 1, which contains, as a sintering aid, a compound of Y, Zr, and at least one of lanthanoids including La, Ce, Pr and Nd, in an amount of 0.01 to 0.5 mass % or less.

3. The substrate material as defined in claim 1, wherein:
the TiCₓO_{y}N_{z} has an average grain size dt satisfying the following relation: 0.05 μm≦dt≦0.5 μm;
the α-Al₂O₃ has an average grain size da satisfying the following relation: 0.1 μm≦da≦1.5 μm; and
the entire sintered body has an average grain size d satisfying the following relation: 0.1 μm≦d≦0.7 μm.

4. The substrate material as defined in claim 1, which contains 0.5 mass % or less of TiOₙ (wherein n<2).

5. The substrate material as defined in any one of claim 1, wherein one or more of or a part of crystal grains of the TiCₓO_{y}N_{z} exist in 2 μm² of square unit area of an arbitrary mirror-finished surface of the sintered body.

6. The substrate material as defined in claim 1, wherein each of a pore having a circle-equivalent average diameter dp of 0.1 μm or more, and a noncircular defect caused by free carbon, exists in 25 μm² of square unit area of an arbitrary mirror-finished surface of the sintered body, in an average number of no more than one.

7. The substrate material as defined in claim 1, wherein an internal stress (τ) calculated by the following formula (1) is 0.5 MPa or less: (1) τ=(B/A)×(Et/r²)×δ, wherein A and B are a constant dependent on a shape of a material (A: 0.67, B: 1.24); E is a Young's modulus; t is a thickness of a substrate; r is a radius of the substrate; τ is an internal stress; and δ is a warp amount of a disk which occurs when the disk is annealed at a temperature of 70% or more of a sintering temperature therefor while adjusting a cooling rate in the range of 0.5 to 3° C./min.

8. A method of manufacturing the substrate material as defined in claim 1, comprising the steps of: preparing a TiCₓO_{y}N_{z} powder (wherein: 0.90≦x<1.0; 0<y≦0.10; 0≦z≦0.05; and 0.90≦x+y+z≦1.0) with an NaCl-type crystal structure which has an average particle size dtp satisfying the following relation: 0.01 μm<dtp<0.2 μm, and contains 0.05 mass % or less of a non-titanium metal-containing material and 0.5 mass % or less of free carbon, and an α-Al₂O₃ powder having an average particle size dap satisfying the following relation: 0.05 μm<dap<0.7 μm, as a target raw material; and sintering the target raw material.

9. A method of manufacturing the substrate material as defined in claim 1, comprising the steps of: preparing a TiCₓO_{y}N_{z} powder (wherein: 0.90≦x<1.0; 0<y≦0.10; 0≦z≦0.05; and 0.90≦x+y+z≦1.0) with an NaCl-type crystal structure which has an average particle size dtp satisfying the following relation: 0.01 μm<dtp<0.2 μm, and contains 0.05 mass % or less of a non-titanium metal-containing material and 0.5 mass % or less of free carbon, an α-Al₂O₃ powder having an average particle size dap satisfying the following relation: 0.05 μm<dap<0.7 μm, and a TiO₂ powder or TiO₂ slurry having an average particle size dto satisfying the following relation: 0.01 μm<dto<0.5 μm, as a target raw material; mixing and milling the target raw material; drying and granulating the milled powder; and sintering the granulated body.

10. A method of manufacturing the substrate material as defined in claim 1, comprising the steps of: mixing a target raw material including: a TiCₓO_{y}N_{z} powder (wherein: 0.90≦x<1.0; 0<y≦0.10; 0≦z≦0.05; and 0.90≦x+y+z≦1.0) having an NaCl-type crystal structure which has an average particle size dtp satisfying the following relation: 0.01 μm<dtp<0.2 μm, and contains 0.05 mass % or less of a non-titanium metal-containing material and 0.5 mass % or less of free carbon; an α-Al₂O₃ powder having an average particle size dap satisfying the following relation: 0.05 μm<dap<0.7 μm; and a TiO₂ powder or TiO₂ slurry having an average particle size dto satisfying the following relation: 0.01 μm<dto<0.5 μm, with a sintering aid consisting of 0.01 to 0.5 mass % or less of any compound of Y, Zr, and lanthanoids including La, Ce, Pr and Nd, and having an average particle size dao satisfying the following relation: 0.01 μm<dao<0.5 μm; mixing and milling the obtained mixture using a medium-agitation mill which is at least one selected from the group consisting of a ball mill, a planetary mill, a rod mill, an attritor and a bead mill; drying and granulate the milled powder; and sintering the granulated body.

11. The method as defined in any one of claim 8, wherein the target raw material is prepared as a TiCₓO_{y}N_{z} powder-α-Al₂O₃ composite powder, wherein the TiCₓO_{y}N_{z} powder (wherein: 0.90≦x<1.0; 0<y≦0.10; 0≦z≦0.05; and 0.90≦x+y+z≦1.0) having an NaCl-type crystal structure which has an average particle size dtp satisfying the following relation: 0.01 μm<dtp<0.2 μm, and contains 0.05 mass % or less of a non-titanium metal-containing material and 0.5 mass % or less of free carbon, covers a part or an entirety of a surface of the α-Al₂O₃ powder having an average particle size dap satisfying the following relation: 0.05 μm<dap<0.7 μm.

12. The method as defined in claim 8, which comprises:
preparing a liquid containing, as a carbon source, an organic substance dissolved in a solvent, the organic substance having one or more OH or COOH groups each of which is a functional group coordinatable to titanium of titanium alkoxide, and including no element, except C, H, N and O;
mixing titanium alkoxide with the liquid in such a manner as to satisfy the following relation: 0.7≦α<1.0, wherein α is a mole ratio of the carbon source to the titanium alkoxide (the carbon source/the titanium alkoxide), to form a precursor solution; and
solidifying the precursor solution, and subjecting the obtained product to a heat treatment in a combination of a vacuum atmosphere and a non-oxidation atmosphere consisting of a gas which is at least one selected from the group consisting of H₂, N₂, Ar and a mixed gas thereof, at 1050 to 1500° C., to prepare the TiCₓO_{y}N_{z} powder to be used for forming the mixed raw material.

13. The method as defined in claim 12, wherein the carbon source is at least one selected from the group consisting of: phenols including phenol and catechol; novolac-type phenolic resin; organic acid including salicylic acid, phthalic acid, catechol and anhydrous citric acid; and ethylenediamine tetraacetic acid (EDTA), or an organic substance having two or more ligands and containing a cyclic compound.

14. The method as defined in claim 12, wherein the carbon source is coordinated to titanium in the product obtained by solidifying the precursor solution.

15. The method as defined in claim 12, wherein the titanium alkoxide is at least one selected from the group consisting of titanium (IV) methoxide, titanium (IV) ethoxide, titanium (IV) isopropoxide and titanium (IV) butoxide.

16. The method as defined in claim 11, which comprises:
mixing titanium alkoxide with a liquid containing, as a carbon source, an organic substance dissolved in a solvent, in such a manner as to satisfy the following relation: 0.75≦α≦1.1, wherein α is a mole ratio of the carbon source to the titanium alkoxide (the carbon source/the titanium alkoxide), to form a precursor solution; and
mixing an α-Al₂O₃ powder with the precursor solution to form a slurry, solidifying the slurry, and subjecting the obtained product to a heat treatment in a combination of a vacuum atmosphere and a non-oxidation atmosphere consisting of a gas which is at least one selected from the group consisting of H₂, N₂, Ar and a mixed gas thereof, at 1050 to 1500° C., to prepare the TiCₓO_{y}N_{z} powder-α-Al₂O₃ composite powder.

17. The method as defined in claim 16, wherein the carbon source is at least one selected from the group consisting of: phenols including phenol and catechol; novolac-type phenolic resin; organic acid including salicylic acid, phthalic acid, catechol and anhydrous citric acid; and ethylenediamine tetraacetic acid (EDTA), or an organic substance having two or more ligands and containing a cyclic compound.

18. The method as defined in claim 16, wherein the carbon source is coordinated to titanium in the product obtained by solidifying the precursor solution.

19. The method as defined in claim 16, wherein the titanium alkoxide is at least one selected from the group consisting of titanium (IV) methoxide, titanium (IV) ethoxide, titanium (IV) isopropoxide and titanium (IV) butoxide.
